(19) United States
(12) Patent Application Publication
(10) Pub. No.: US 2011/0166295 A1
(43) Pub. Date: Jul. 7, 2011

(54) IMPROVED MONOVINYLIDENE AROMATIC POLYMER COMPOSITIONS COMPRISING POLY-ALPHA-OLEFIN ADDITIVES

(75) Inventors: Gilbert Bouquet, Gent (BE); Roeland Vossen, Hulst (NL); Rik Vanecckhoutte, Eeklo (BE); Jean Peltier, Lille (FR)

(73) Assignee: Styron Europe GmbH, Horgen (CH)

(21) Appl. No.: 13/062,424

(22) PCT Filed: Sep. 15, 2009
(86) PCT No.: PCT/US09/56941

§ 371 Date: Mar. 4, 2011

Related U.S. Application Data
(60) Provisional application No. 61/098,356, filed on Sep. 19, 2008.

(51) Int. Cl. C08F 279/02

(52) U.S. Cl. 525/316

(57) ABSTRACT

Compositions comprising (a) a rubber-modified monovinylidene aromatic polymer, e.g., HIPS, and (b) a specified poly-alpha-olefin (PAO), e.g., an oligomer of hexene, octene, decene, dodecene and/or tetradecene, that has a dynamic viscosity value of from about 40 to about 500 centipoise (cP) at 40° C., exhibit improved combinations of environmental stress crack resistance, impact resistance and heat resistance as compared to compositions without such a PAO. The compositions are useful in the manufacture of articles, e.g., refrigerator liners and food packaging, which come in contact with the oils contained in various food stuffs.

### CROSS REFERENCE STATEMENT

This application claims benefit of U.S. Provisional Application No. 61/098,356, filed Sep. 19, 2008.

### FIELD OF THE INVENTION

This invention relates to compositions comprising rubber-modified monovinylidene aromatic polymers. In one aspect, the invention relates to compositions comprising rubber-modified monovinylidene aromatic polymers admixed with a relatively low viscosity poly-alpha-olefin (PAO) while in another aspect, the invention relates to a process for preparing rubber-modified monovinylidene aromatic polymers admixed with a low viscosity PAO. In yet another aspect, the invention relates to a process of increasing the environmental stress crack resistance (ESCR) of a composition comprising a rubber-modified monovinylidene aromatic polymer by admixing with the polymer a small amount of a PAO.

### BACKGROUND OF THE INVENTION

High impact (i.e., rubber-modified) polystyrene (HIPS) is a common rubber-modified monovinylidene aromatic polymer used in many applications such as, for instance, refrigerator liners and food and beverage packaging containers. Both with refrigerator liners and food packaging, resistance to the oils and fats contained in food stuffs is critical to ensure lasting performance. This resistance to oils and fats, e.g., corn oil, palm oil, etc., is generally tested by the environmental stress crack resistance (ESCR) test where article specimens are placed under strain in an oil or fat of choice, and the tensile properties of the specimens are measured at timed intervals. Good property combinations of toughness, as typically measured by impact resistance, and heat resistance are also important to good performance in these and other applications.

For obvious reasons there is a continuing interest to upgrade the ESCR performance and overall property combinations of HIPS and similar materials. Current methods include polymer modification in the areas of the rubber content, the rubber morphology (i.e., larger rubber particle size, rubber phase volume, etc.), the matrix molecular weight, and/or the matrix molecular weight distribution of the polymer. These choices, however, significantly reduce the degrees of freedom within the process for the making and molding the polymer, and can reduce the qualities of the polymer itself.

In commonly assigned, unpublished PCT Patent Application US08/069969 designating the United States it is taught that improved ESCR in a monovinylidene aromatic polymer is provided by ethylene alpha-olefin copolymers characterized by a particular mathematical relationship between ethylene content and dynamic viscosity.

In another method to improve the ESCR of a HIPS polymer, US2004/0001962 teaches the use of polyisobutylene, certain polymerized alpha-olefins of at least 10 carbon atoms, atactic polypropylene, or a polyolefin copolymer with optional use of mineral oil. With respect to the use of a PAO additive (referred to as synthetic hydrocarbons in this reference), it apparently teaches relatively high viscosity PAO's. At one point this reference teaches a viscosity range of 200 to 1000 centistokes (cSt) at 99° C., at another point teaching a different viscosity range of from 100 to 500 centipoise (cP) at 99° C. (ASTM D-3236) and at yet another point apparently using an example PAO which, according to the manufacturer's product information, had a viscosity at 99° C. of 54 cP (which converts to 63 cSt at 99° C.) and is outside both of the ranges that are taught.

### SUMMARY OF THE INVENTION

The present invention is based on the discovery that the ability of PAO's to increase the ESCR and overall physical property balance of a monovinylidene aromatic polymer and be useful in a typical polymerization process is based on the dynamic viscosity of the PAO. In this regard, the present invention describes both a composition comprising monovinylidene aromatic polymer with a PAO additive that provides improved physical property combinations, and a process for improving the physical property combinations of a composition comprising a monovinylidene aromatic polymer. The compositions of this invention exhibit improved physical property combinations, including ESCR, toughness and heat resistance, and are more readily suited to typical commercial production processes relative to a composition comprising a monovinylidene aromatic polymer without a PAO that is characterized by the required dynamic viscosity.

Thus, one embodiment of the invention is a composition comprising (A) a rubber-modified monovinylidene aromatic polymer, and (B) an effective amount of a poly-alpha-olefin (PAO) having a dynamic viscosity (ASTM D-3236) of from about 40 to about 500 centipoise (cP) at 40° C. In other embodiments the PAO is present in an amount of from at least about 0.1 to about 10, preferably from at least about 1 to about 7 weight percent based on the combined weight of the rubber-modified monovinylidene aromatic polymer and the PAO. The dynamic viscosity of the PAO is preferably at least about 50 cP at 40° C. and preferably less than or equal to about 400 cP at 40° C. In one embodiment the rubber-modified monovinylidene aromatic polymer is rubber-modified polystyrene (HIPS) or butadiene rubber-modified poly(styrene-acrylonitrile) (ABS). In further embodiments of the present invention the PAO can be an oligomer based on one or more of the alpha olefin monomers selected from group comprising hexene, octene, decene, dodecene, and tetradecene; or the oligomer can be based on a mixture of the alpha olefin monomers octene, decene, and dodecene; or it can be based on a mixture of alpha olefin monomers comprising decene; or it can be based on a mixture of alpha olefin monomers comprising dodecene.

In one embodiment of the present invention the notched Izod impact resistance of the compositions, when tested according to ISO 180/1A, is improved by at least 10%, preferably at least 20%, more preferably at least 30% as compared to a reference sample containing no PAO. In a further embodiment the compositions according to the present invention when tested according to the procedure of ISO 527-2 retains more than 30%, preferably more than 40%, more preferably greater than 50% of its original elongation after seven days exposure to corn oil at 1% strain in accordance with the procedure of ISO-4599. In another embodiment a test specimen prepared from the composition according to the present invention, when tested according to the procedure of ASTM D-1525 (120° C./h), exhibits a Vicat heat resistance temperature of greater than 102° C.

In another embodiment, the present invention is a process for preparing an improved rubber-modified monovinylidene aromatic polymer comprising the step of admixing with the rubber-modified monovinylidene aromatic polymer an effective amount of a PAO having a dynamic viscosity of from about 40 to about 500 centipoise (cP) at 40° C., preferably wherein the PAO is admixed with the rubber-modified monovinylidene aromatic polymer by addition to the polymerization process prior to or at the time the polymer is prepared by polymerization of its constituent monomers. In another embodiment, the present invention is a process to improve the ESCR of a rubber-modified monovinylidene aromatic polymer comprising the step of admixing with the rubber-modified monovinylidene aromatic polymer an effective amount of a PAO, preferably wherein the PAO is admixed with the rubber-modified monovinylidene aromatic polymer by addition into the polymerization process prior to or at the time the polymer is prepared by polymerization of its constituent monomers. In a further embodiment the present invention is an article comprising the one of the compositions as described above.

### DESCRIPTION OF THE PREFERRED EMBODIMENT

It is initially noted that the numerical ranges in this disclosure include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, molecular weight, dynamic viscosity, the number of carbon atoms in a PAO (co) monomer, the amount of PAO in the composition, and the various properties of the PAO and compositions of the invention.

“Polymer” means a polymeric compound prepared by polymerizing monomers, whether of the same or a different type. The generic term polymer thus embraces the term homopolymer, usually employed to refer to polymers prepared from only one type of monomer, and the terms copolymer and interpolymer as defined below.

“Copolymer”, “interpolymer” and like terms means a polymer prepared by the polymerization of at least two different types of monomers. These generic terms include the traditional definition of copolymers, i.e., polymers prepared from two different types of monomers, and the more expansive definition of copolymers, i.e., polymers prepared from more than two different types of monomers, e.g., terpolymers, tetrapolymers, etc.

“Blend”, “polymer blend” and like terms mean a composition of two or more compounds, typically two or more polymers. Such a blend may or may not be miscible. Such a blend may or may not be phase separated. Such a blend may or may not contain one or more domain configurations, as determined from transmission electron spectroscopy, light scattering, x-ray scattering, or any other method known in the art. In the context of this invention, blend includes the chemical and/or physical coupling of the monovinylidene aromatic polymer with the PAO, e.g., the latter is grafted onto or otherwise incorporated into the former.

“Composition” and like terms means a mixture or blend of two or more components. One composition of this invention is the mix of monomers, polymerization initiator and any other components necessary or desirable to make the monovinylidene aromatic polymer, while another composition of this invention is the mix comprising the monovinylidene aromatic polymer, PAO and any other components, e.g., additives, necessary or desirable to the end use of the composition.

“Article” and like terms mean an object made from a composition of this invention. Articles include, without limitation, film, fiber, sheet structures, molded objects such as appliance and automobile parts, hoses, refrigerator and other liners, clothing and footwear components, gaskets and the like made by any forming and/or shaping process, e.g., extrusion, casting, injection molding, blow molding, thermoforming etc.

“ESCR” is measured consistent with International Standard ISO-4599. Test specimens are molded for tensile testing consistent with ISO-527. The test procedure requires measuring a tensile property (elongation at break) of the test specimens (bars) of the candidate resin(s) before and after they are immersed in corn oil under measured strain. The temperature during the test is 23±2° C., and the test bar samples of the candidate resins are clamped into a frame that applies 1.0% strain (sometimes 0.5% strain is applied). The test bar, being held under strain in the frame, is held submerged in corn oil for 7 days. After the specified time, bars are removed from the corn oil, removed from the frame, cleaned and the percentage elongation at break (“Elong”) measured. From the before and after elongation test results, the retention percentage (versus the test value for the unsubmerged bar) is calculated and used to characterize the ESCR performance for that sample. This property retention value is referred to as the “environmental stress crack resistance” and is shown below as “ESCR 1% strain”. The criterion for generally successful or sufficient ESCR performance is that test specimens exposed at 1% strain after 7 days immersion retain at least 10%, and preferably at least about 20% of the value of the tested tensile property measured on unexposed test specimens.

PAO's as used in the practice of this invention are low molecular weight polymers (also referred to as “oligomers”) made from alpha olefins having from at least 6 carbons up to about 14 carbons and can be homopolymers or copolymers of two or more of these monomeric units provided that the polymer composition will meet the PAO specifications as prescribed below. Typical PAO's suitable for use according to the present invention comprise monomeric units (i.e., monomers), having at least 6, preferably at least 8, more preferably at least 10 carbon atoms, and a maximum of 20 carbon atoms, preferably 18, more preferably 16, and most preferably a maximum of 14 carbon atoms. Such PAO's include but are not limited to oligomers of one or more of the monomers hexene, octene, decene, dodecene and tetradecene, including especially the “co-oligomers” that are prepared from the mixtures of two or more of these monomers, which monomer mixtures are often produced in the monomer production processes. These PAO products are commercially available and generally known to those skilled in the art as discussed further below. Suitable PAO's include oligomers based on decene or a decene-rich stream (“oligo-decene”) and PAO's based on dodecene or a dodecene-rich stream (“oligo-dodecene”). As will be discussed in more detail below, blends of two or more PAO's can also be used provided that the blend composition will meet the PAO specifications as prescribed below.

In the key characterization of the PAO's suited for use in present invention, it has been found that PAO's having a dynamic viscosity in a specified range provide an optimized combination of processability in a commercial monovinylidene aromatic polymer polymerization process and physical properties and performance in the resulting polymer. By “processability” it is meant that the PAO's are handled and incorporated into the polymerization process as a liquid at room temperature.

For providing the necessary improvements in ESCR, the preferred PAO's have a dynamic viscosity at 40° C. of at least 40 centipoise (cP), preferably at least 42, more preferably at least 45, more preferably at least 48 centipoise (cP) as determined by ASTM D-3236. To maintain the ESCR improvements and be readily processable in monovinylidene aromatic polymer production, the preferred PAO's have a dynamic viscosity of less than 500 cP as determined at 40° C. by ASTM D-3236, preferably less than 450, more preferably less than 400 and more preferably less than 375 cP. Although viscosity can be measured at different temperatures, it has been found that measuring at 40° C. provides the better differentiation and categorization for the PAO's used within the present invention.

As known to those generally skilled in this area of technology, dynamic viscosity is determined in accordance with the following procedure, using a Brookfield Laboratories DVII+ Viscometer and disposable aluminum sample chambers (and for this reason is sometimes referred to as the Brookfield Viscosity). Spindle 18 is best used for measuring these viscosities; Spindle SC-31 may also be used if the measured viscosity is within the range for which the spindle is specified. The sample is poured into the chamber which is, in turn, inserted into a Brookfield Thermosel and locked into place. The sample chamber has a notch on the bottom that fits the bottom of the Brookfield Thermosel to ensure that the chamber is not allowed to turn when the spindle is inserted and spun. The sample is heated to the required temperature until the melted sample is about 1 inch (approximately 8 grams of resin) below the top of the sample chamber. The viscometer apparatus is lowered and the spindle submerged into the sample chamber. Lowering is continued until brackets on the viscometer align on the Thermosel. The viscometer is turned on and set to operate at a shear rate which leads to a torque reading in the range of 30 to 60 percent. Readings are taken every minute for about 15 minutes, or until the values stabilize, at which point a final reading is recorded.

Dynamic viscosity values (units in cP) and Kinematic viscosity values (units in cSt) at a given temperature can be converted to the other using the materials' densities at said temperature by the following relationship:

Kinematic Viscosity×density=Dynamic Viscosity

For purposes of the present invention and comparison with the viscosity measurements shown in the prior art, it is noted that viscosity values determined that 99° C. are considered essentially the same as and are directly comparable to values determined at 100° C. This can also be said for measurements at 38 and 40° C.

The PAO's suitable for use according to the present invention typically have a density of from greater than about 0.83 to less than about 0.86 grams per cubic centimeter (g/cm³) at 15.6° C. (60° F.), preferably from about 0.84 to 0.85 g/cm³. Density is determined in accordance with American Society for Testing and Materials (ASTM) procedure ASTM D-7042.

The PAO's of this invention typically have a pour point of less than −20, preferably less than −25 and more preferably less than −30, ° C. as determined by ASTM D-97.

In general, the PAO's suitable for use according to this invention are known and are commercially available. They are typically produced using a multistage process that begins with ethylene as the building block to prepare a alpha olefin or, more typically a mixture of alpha olefin monomers, preferably containing mainly one of the monomers. Such processes are typically designed to produce a stream that is “rich” in one of the monomers, such as octene, decene, dodecene, or tetradecene, but also produces some amounts of the monomers having more or less ethylene units, resulting in a mixture. The alpha olefin mixture is then oligomerized using conventional olefin polymerization technology, e.g., free radical, cationic, metallocene, post-metallocene or constrained geometry catalysis to provide a poly-alpha-olefin and typically gives a mixture of dimers, trimers, tetramers and higher oligomers of the monomers in the mixture. The alpha olefin monomer that has the highest concentration, i.e., is “rich” in the monomer mixture, is herein referred to as the main or base monomer for the PAO. For example, if an alpha olefin monomer mixture is rich decene, the PAO is referred to as is a decene oligomer or a decene PAO even though it will contain some co-oligomerized amounts of other monomers such as octene, dodecene and tetradecene.

Then, this mixture of oligomers can be distilled to permit the tailoring of the oligomer distribution and produce specific product cuts designated by their dynamic viscosities. In addition, these highly branched oligomers can optionally be hydrogenated and filtered. Hydrogenation may optionally be used to give the final product enhanced chemical inertness and added oxidative stability. A wide range of PAO viscosities are produced and commercially available and can be selected or blended to provide a PAO within the desired viscosity range.

The PAO's of this invention can be used alone or in combination with one or more other PAO's in the form of a blend of PAO's that differ from one another by viscosity, composition, unsaturation, catalytic method of preparation, etc. If the PAO is a blend of two or more PAO's of different viscosities, pour points and/or densities, then the blend will need to have a viscosity value, pour point and/or density within the range or ranges as taught above.

Where combinations or blends of the PAO's are used, they can be blended together by any pre-reactor, in-reactor or post-reactor process.

The PAO components are incorporated into the monovinylidene aromatic polymers of the present invention in an “effective amount” that provides a significant improvement in at least one, preferably two, of the desired physical properties; i.e., improvements of 10% for ESCR, 2% for notched Izod impact resistance, 1% for yield strength, and 0.5% for Vicat heat resistance). Typically, this amount is at least about 0.1 weight percent (wt %) based upon the combined weight of the monovinylidene aromatic polymer and the PAO, preferably at least about 0.3, more preferably at least about 0.5, more preferably at least about 1, more preferably at least about 1.5, and even more preferably at least about 2, wt % based on the combined weight of the monovinylidene aromatic polymer and the PAO. The maximum amount of PAO in the composition can vary widely and is more a function of economics and diminishing returns than anything else but as a practical matter, the maximum amount is typically not in excess of about 10 wt %, more typically not in excess of about 7 and even more typically not in excess of about 5 wt % based on the combined weight of the monovinylidene aromatic polymer and the PAO.

Monovinylidene Aromatic Polymers

Monovinylidene aromatic homopolymers and copolymers (individually and collectively referred to as “polymers” or “copolymers”) are produced by polymerizing monovinylidene aromatic monomers such as those described in U.S. Pat. Nos. 4,666,987, 4,572,819 and 4,585,825. The monovinylidene aromatic monomers suitable for producing the polymers and copolymers used in the practice of this invention are preferably of the following formula:

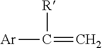

in which R′ is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl (in which the alkyl group of the phenyl ring contains 1 to 10, preferably 1 to 8 and more preferably 1 to 4, carbon atoms), with phenyl being most preferred. Typical monovinylidene aromatic monomers which can be used include: styrene, alpha-methylstyrene, all isomers of vinyl toluene, especially para-vinyltoluene, all isomers of ethyl styrene, propyl styrene, vinyl biphenyl, vinyl naphthalene, vinyl anthracene and the like, and mixtures thereof with styrene being the most preferred.

The monovinylidene aromatic monomer can be copolymerized with one or more of a range of other copolymerizable monomers. Preferred comonomers include nitrile monomers such as acrylonitrile, methacrylonitrile and fumaronitrile; (meth)acrylate monomers such as methyl methacrylate or n-butyl acrylate; maleic anhydride and/or N-aryl maleimides such as N-phenylmaleimide, and conjugated and nonconjugated dienes. Representative copolymers include styrene-acrylonitrile (SAN) copolymers. The copolymers typically contain at least about 1, preferably at least about 2 and more preferably at least about 5, wt % of units derived from the comonomer based on weight of the copolymer. Typically, the maximum amount of units derived from the comonomer is about 40, preferably about 35 and more preferably about 30, wt % based on the weight of the copolymer. These homopolymers or copolymers are blended or grafted with one or more elastomeric polymers to produce high impact (i.e., rubber-modified) polystyrene (HIPS) and butadiene rubber-modified poly(styrene-acrylonitrile) (ABS) resins.

The weight average molecular weight (Mw) of the monovinylidene aromatic polymers used in the practice of this invention can vary widely. For reasons of mechanical strength, among others, typically the Mw is at least about 100,000, preferably at least about 120,000, more preferably at least about 130,000 and most preferably at least about 140,000 g/mol. For reasons of processability, among others, typically the Mw is less than or equal to about 400,000, preferably less than or equal to about 350,000, more preferably less than or equal to about 300,000 and most preferably less than or equal to about 250,000 g/mol.

Similar to the Mw, the number average molecular weight (Mn) of the monovinylidene aromatic polymers used in the practice of this invention can also vary widely. Again for reasons of mechanical strength, among others, typically the Mn is at least about 30,000, preferably at least about 40,000, more preferably at least about 50,000 and most preferably at least about 60,000 g/mol. Also for reasons of processability, among others, typically the Mn is less than or equal to about 130,000, preferably less than or equal to about 120,000, more preferably less than or equal to about 110,000 and most preferably less than or equal to about 100,000 g/mol.

Along with the Mw and Mn values, the ratio of Mw/Mn, also known as polydispersity or molecular weight distribution, can vary widely. Typically, this ratio is at least about 2, and preferably greater than or equal to about 2.3. The ratio typically is less than or equal to about 4, and preferably less than or equal to about 3. The Mw and Mn are typically determined by gel permeation chromatography using polystyrene standards for calibration.

The rubber suitable for use in the present invention can be any unsaturated rubbery polymer having a glass transition temperature (Tg) of not higher than about 0° C., preferably not higher than about −20° C., as determined by ASTM D-756-52T. Tg is the temperature or temperature range at which a polymeric material shows an abrupt change in its physical properties, including, for example, mechanical strength. Tg can be determined by differential scanning calorimetry (DSC).

Suitable rubbers include, but are not limited to, diene rubbers, diene block rubbers, butyl rubbers, ethylene propylene rubbers, ethylene-propylene-diene monomer (EPDM) rubbers, ethylene copolymer rubbers, acrylate rubbers, polyisoprene rubbers, halogen-containing rubbers, silicone rubbers and mixtures of two or more of these rubbers. Also suitable are interpolymers of rubber-forming monomers with other copolymerizable monomers. Suitable diene rubbers include, but are not limited to, conjugated 1,3-dienes, for example, butadiene, isoprene, piperylene, chloroprene, or mixtures of two or more of these dienes. Suitable rubbers also include homopolymers of conjugated 1,3-dienes and interpolymers of conjugated 1,3-dienes with one or more copolymerizable monoethylenically unsaturated monomers, for example, copolymers of isobutylene and isoprene.

Preferred rubbers are diene rubbers such as polybutadiene, polyisoprene, polypiperylene, polychloroprene, and the like or mixtures of diene rubbers, i.e., any rubbery polymers of one or more conjugated 1,3-dienes, with 1,3-butadiene being especially preferred. Such rubbers include homopolymers and copolymers of 1,3-butadiene with one or more copolymerizable monomers, such as monovinylidene aromatic monomers as described above, styrene being preferred. Preferred copolymers of 1,3-butadiene are block or tapered block rubbers of at least about 30, more preferably at least about 50, even more preferably at least about 70, and still more preferably at least about 90 wt % 1,3-butadiene rubber, and preferably up to about 70, more preferably up to about 50, even more preferably up to about 30, and still more preferably up to about 10, wt % monovinylidene aromatic monomer, all weights based on the weight of the 1,3-butadiene copolymer.

The rubbers suitable for use in the present invention are preferably those that have a solution viscosity in the range of about 5 to about 300 cP (5 percent by weight in styrene at 20° C.) and Mooney viscosity of about 5 to about 100 (ML1+4, 100° C.).

The rubber in the rubber-modified polymers of this invention, for purposes of maintaining reduced cost and good physical property combinations, is typically present in an amount equal to or less than about 40 wt % based on the weight of rubber modified polymer, preferably equal to or less than about 25, more preferably equal to or less than about 20, even more preferably equal to or less than about 15, and most preferably equal to or less than about 10 wt % based on the weight of the rubber-modified polymer. The rubber in the rubber-modified polymers of this invention is typically present in an amount as needed to provide sufficient toughness and tensile strength for a given application. An initial criterion for sufficient tensile strength is exhibiting a percentage elongation at break value of at least about 10% and preferably at least about 20% as measured according to ISO 527-2. In general, the rubber is present in an amount of at least about 1 wt % based on the weight of rubber modified polymer, preferably at least about 2, more preferably at least about 3, even more preferably at least about 4, and most preferably at least about 5 wt % based on the weight of the rubber-modified polymer. Typically, HIPS products contain less rubber than ABS products.

The rubber particles in the compositions according to the present invention, in order to provide sufficient initial toughness and sufficient ESCR, will typically have a volume average diameter of at least about 0.05 micrometers (“μm”), preferably at least about 0.1 μm, more preferably at least about 1 μm, more preferably greater than 2 μm, and most preferably at least about 3 μm and typically less than or equal to about 10 μm, preferably less than or equal to about 7 μm and most preferably less than or equal to about 5 μm. As used herein, the volume average rubber particle size or diameter refers to the diameter of the rubber particles, including all occlusions of monovinylidene aromatic polymer within the rubber particles. Particle sizes in these ranges can typically be measured using the electro sensing zone method, such as the Multisizer™ brand equipment provided by Beckman Coulter, Inc. or using measurement techniques based on light scattering (Malvern Mastersizer, Beckman Coulter LS 230). If needed, transmission electron microscopy analysis can be used for rubber particle size and morphology analysis. Those skilled in the art recognize that different sized groups of rubber particles may require some selection or modification of rubber particle measurement techniques for optimized accuracy.

Although any of the generally well-known processes to make the rubber-modified monovinylidene aromatic polymers can be used, a preferred process is based on polymerizing monovinylidene aromatic monomer(s) (and any optional comonomer) to make the polymer in the presence of the rubber using multiple reactors and/or reaction zones connected in series. As known to those skilled in the art, these reactors/zones can use the same or different initiators/reactants and/or be operated at different conditions, e.g., different reactant concentrations, temperatures, pressures, etc. to provide a range of features and variations in the monovinylidene aromatic polymers. This process provides a desirable rubber-modified monovinylidene aromatic polymer composition comprising a dispersion of rubber particles, preferably grafted with monovinylidene aromatic polymer, in the monovinylidene aromatic polymer matrix.

The PAO's can be combined or blended into the monovinylidene aromatic polymer by any pre-reactor, in-reactor or post-reactor mixing or blending process. The pre-reactor or in-reactor blending processes where the PAO is admixed with the rubber-modified monovinylidene aromatic polymer by addition into the polymerization process prior to or at the time the polymer is prepared by polymerization of its constituent monomers is preferred to the post-reactor blending processes. In one embodiment of the present invention, the PAO component(s) as specified above are added as a liquid into the monovinylidene aromatic polymer polymerization process, preferably to the monomer solution, to the dissolved rubber feed solution or elsewhere during or preferably prior to initiation of the polymerization reaction.

Alternatively, the PAO component can be provided into the monovinylidene aromatic polymer resin by any of the generally well known mixing techniques as used for other additives.

### Fillers and Additives

The compositions of this invention can further comprise one or more fillers and/or additives as long as they do not detrimentally affect the desired property combinations that are otherwise obtained or, preferably, they would improve one or more of the properties. For example, mineral oil is one such additive for HIPS that may improve the ESCR of HIPS. These materials are added in known amounts using conventional equipment and techniques. Other representative fillers include talc, calcium carbonate, organo-clay, glass fibers, marble dust, cement dust, feldspar, silica or glass, fumed silica, silicates, alumina, various phosphorus compounds, ammonium bromide, antimony trioxide, antimony trioxide, zinc oxide, zinc borate, barium sulfate, silicones, aluminum silicate, calcium silicate, titanium oxides, glass microspheres, chalk, mica, clays, wollastonite, ammonium octamolybdate, intumescent compounds, expandable graphite, and mixtures of two or more of these materials. The fillers may carry or contain various surface coatings or treatments, such as silanes, fatty acids, and the like.

Still other additives include flame retardants such as the halogenated organic compounds. The composition can also contain additives such as, for example, antioxidants (e.g., hindered phenols such as, for example, IRGANOX™ 1076 a registered trademark of Ciba Specialty Chemicals), mold release agents, processing aids other than mineral oil (such as other oils, organic acids such as stearic acid, metal salts of organic acids), colorants or pigments to the extent that they do not interfere with desired physical or mechanical properties of the compositions of the present invention.

Other Polymers

The compositions of this invention can comprise polymers other than the monovinylidene aromatic polymers and the low molecular weight PAO's. Representative other polymers include, but are not limited to, ethylene polymer (e.g., low density polyethylene (LDPE), ultra low density polyethylene (ULDPE), medium density polyethylene (MDPE), linear low density polyethylene (LLDPE), high density polyethylene (HDPE), homogeneously branched linear ethylene polymer, substantially linear ethylene polymer, graft-modified ethylene polymers, ethylene vinyl acetate interpolymer, ethylene acrylic acid interpolymer, ethylene ethyl acetate interpolymer, ethylene methacrylic acid interpolymer, ethylene methacrylic acid ionomer, and the like), conventional polypropylene (e.g., homopolymer polypropylene, polypropylene copolymer, random block polypropylene interpolymer and the like), polyether block copolymer (e.g., PEBAX), polyphenylene ether, copolyester polymer, polyester/polyether block polymers (e.g., HYTEL), ethylene carbon monoxide interpolymer (e.g., ethylene/carbon monoxide (ECO), copolymer, ethylene/acrylic acid/carbon monoxide (EAACO) terpolymer, ethylene/methacrylic acid/carbon monoxide (EMAACO) terpolymer, ethylene/vinyl acetate/carbon monoxide (EVACO) terpolymer and styrene/carbon monoxide (SCO)), polyethylene terephthalate (PET), chlorinated polyethylene, styrene-butadiene-styrene (SBS) interpolymer, styrene-ethylene-butadiene-styrene (SEBS) interpolymer, and the like and mixtures of two or more of these other polymers. The polyolefins that can comprise one or more of the other polymers include both high and low molecular weight polyolefins, and saturated and unsaturated polyolefins. If the composition comprises one or more other polymers, then the other polymers typically comprise no more than about 20 percent by weight of the total weight of the composition, preferably no more than about 15, more preferably no more than about 10, more preferably no more than about 5, and most preferably no more than about 2 percent by weight of the total weight of the composition.

The compositions of this invention are used in refrigerator and other liners and food and other packaging construction in the same manner as known compositions. In addition to these manufactures, the compositions of this invention can be used in the manufacture of such articles as, but not limited to sheet materials, gaskets, apparel, footwear, hoses and tubing, components for consumer electronics and appliances, and the like. These compositions are used in the same manner as known compositions of monovinylidene aromatic polymers and mineral oil to produce articles of manufacture which are typically shaped or molded by known processes, e.g., extrusion, molding, thermoforming, etc.

The following experiments illustrate various embodiments of this invention. All parts and percentages are by weight unless otherwise indicated.

The PAO's used in the following experiments are shown below in Table 1 and have the indicated physical properties measured, unless indicated differently, according to the following test methods:

| | |
|---|---|
| Dynamic viscosity (“Dyn Visc”) | ASTM D-3236 |
| Kinematic viscosity (“Kin Visc”) | ASTM D-445 |
| Pour point | ASTM D-97 |
| Density | ASTM D-4052 |

The dynamic viscosity values were determined by Applicants using spindle 18 at the indicated temperatures. All the other property data below was obtained from the literature or other information supplied by the PAO suppliers, including the molecular weight shown as “MW calc GC”, referring to gas chromatography measurement techniques. It is noted that the “monomer” information shown below for the PAO's was inferred from their CAS numbers that indicated generally the oligomer species that are present in the PAO. Also, it should be noted the Vybar 825 brand PAO that was utilized in prior art document US2004/0001962 was not utilized in any of the experiments in the present application, the available information is provide below for comparison purposes only.

TABLE 1
PAO Component Data

| | | | Dyn Visc | Dyn Visc | Kin Visc | Kin Visc | Pour | Density | Mw calc |
|---|---|---|---|---|---|---|---|---|---|
| | | Base | @100° C. | @40° C. | @100° C. | @40° C. | point | @15.6° C. | GC |
| PAO | Supplier | Monomer | cP | cP | cSt | cSt | ° C. | g/cm3 | g/mol |
| Durasyn 164 | Ineos | Decene | 3 | 14 | 4 | 17 | −65 | 0.82 | 443 |
| Durasyn 145 | Ineos | Dodecene | 4 | 20 | 5 | 25 | −45 | 0.83 | |
| Durasyn 148 | Ineos | Dodecene | 6 | 35 | 8 | 44 | −45 | 0.83 | |
| Durasyn 170 | Ineos | Decene | 7 | 50 | 10 | 65 | −45 | 0.84 | 690 |
| Durasyn 174 | Ineos | Decene | 32 | 329 | 40 | 400 | −30 | 0.85 | 1400 |
| Durasyn 180 | Ineos | Decene | 79 | 1039 | 100 | 1275 | −18 | 0.85 | 2000 |
| Spectrasyn 10 | Exxon Mobil | Decene**** | 8 | 56 | 10 | 66 | −54 | 0.84 | |
| Spectrasyn 40 | Exxon Mobil | Decene**** | 31 | 320 | 39 | 396 | −36 | 0.85 | |
| Vybar 825 | Baker Petrolite | N/A | 54* | 530** | | | −34 | 0.86*** | |

*@98.9° C.
**@37.8° C.
***ASTM D-1168@ 24° C.
****Appears also to include amounts of octene and dodecene.

The two blended PAO compositions shown in Tables 4 and 6 below were 1:1 weight ratio blends of the two indicated components prepared in advance by mixing.

The sample monovinylidene aromatic polymer resin compositions are produced in a continuous process using three agitated reactors working in series. The PAO(s) and low viscosity white mineral oil (“WMO”, Drakeol™ 35 Penreco), where employed, were mixed into the feed solution also containing the rubber, ethyl benzene (EB), styrene and the remainder of the additives (i.e., peroxide initiator and chain transfer agent), which feed solution was supplied to the first reactor.

The antioxidant is added later in the reaction. The feed compositions are reported in Table 2 (styrene constitutes the balance of the feed). The peroxide initiator is Trigonox™ 22 available from Akzo-Nobel, and the chain transfer agent is n-dodecyl mercaptan (nDM). The polybutadiene used had a solution viscosity of 165 cP at 25° C. as a 5.43 wt % solution in toluene.

TABLE 2
Feed Compositions

| | | PAO |
|---|---|---|
| Feed Composition | Experiment 1 | Experiments |
| Polybutadiene rubber (wt %) | 6 | 6 |
| Ethylbenzene (wt %) | 6 | 6 |
| Styrene | Balance | Balance |
| PAO (wt %) | 0 | 3 |
| WMO (wt %) | 3 | 0 |
| Irganox 1076 (wt %) | 0.1 | 0.1 |
| Trigonox 22 (ppm) | 80 | 80 |
| nDM (ppm) | 300 | 300 |

The polymerization is continued until about 75-80% solids are reached. Residual styrene and ethylbenzene diluent are flashed off and the rubber is crosslinked in a devolatilizing extrusion step. The samples are extruded through a die and are cut in pellets. Based on the feed composition, conversion and devolatilization, it is believed that the final polymer compositions contained about 3.5 weight percent of the PAO or WMO components, about 7.5 to 8 weight percent rubber, and the balance polystyrene.

The test methods used to characterize the samples are described in Table 3.

TABLE 3
Test Methods

| | |
|---|---|
| Rubber Particle Size | Coulter Multisizer 30 μm |
| Tensile Properties | ISO 527-2 |
| Notched Izod Impact Resistance | ISO 180/1A |
| Tensile Modulus (“Modulus”) | ASTM D-1525 (120° C./h) |
| ESCR | ISO 4599 |

TABLE 4
Test Results

| | | Dyn Visc | RPS | Elong | Elong | ESCR | n | Δ n | | Δ | Yield | Δ Yield |
|---|---|---|---|---|---|---|---|---|---|---|---|---|
| | | @40° C. | mean | 0 days | 7 days | 1% strain | Izod | Izod | Vicat | Vicat | Strength | Strength |
| Expt | ESCR Additive | cP | μm | % | % | % | J/m | % | ° C. | % | MPa | % |
| 1* | WMO | | 4.0 | 32 | 1 | 3 | 103 | | 101.2 | | 17.9 | |
| 2* | Durasyn 164 | 14 | 5.3 | 43 | 2 | 5 | 107 | 4 | 100.8 | 0 | 17.6 | −2 |
| 3* | Durasyn 145 | 20 | 5.0 | 44 | 1 | 2 | 111 | 8 | 99.3 | −2 | 16.4 | −8 |
| 4* | Durasyn 148 | 35 | 5.1 | 49 | 2 | 4 | 121 | 17 | 99.6 | −2 | 16.6 | −7 |
| 5 | Durasyn 170 | 50 | 5.1 | 38 | 34 | 89 | 113 | 10 | 100.1 | −1 | 16.9 | −6 |
| 6 | Spectrasyn 10 | 56 | 6.1 | 47 | 29 | 62 | 115 | 12 | 100.3 | −1 | 16.1 | −10 |
| 7 | Durasyn 174/170 | 117** | 5.2 | 55 | 32 | 58 | 146 | 42 | 102.8 | 2 | 19.2 | 7 |
| 8 | Spectrasyn 40/10 | 124** | 4.5 | 54 | 32 | 59 | 143 | 39 | 102.9 | 2 | 18.4 | 3 |
| 9 | Spectrasyn 40 | 320 | 3.8 | 54 | 36 | 67 | 147 | 43 | 104.8 | 4 | 20.7 | 16 |
| 10 | Durasyn 174 | 329 | 3.5 | 52 | 21 | 40 | 143 | 39 | 104.5 | 3 | 22.5 | 26 |
| 11* | Durasyn 180 | 1039 | 4.5 | 37 | 5 | 13 | 92 | −11 | 106.1 | 5 | 25.7 | 44 |

*Comparative Experiment -- not an example of the present invention
**Calculated using Refutas method

Table 4 demonstrates the beneficial results of adding a PAO within the specified viscosity range to a monovinylidene aromatic polymer. All compositions passed an initial screening criterion for sufficient tensile strength, exhibiting a percentage elongation at break value (“Elong”) of at least about 10% (and preferably at least about 20%) as measured according to ISO 527-2. However, after the corn oil exposure and ESCR testing, Experimental compositions 5 through 10 show improved ESCR, as assessed by the improved retention of their elongation at break values (“ESCR 1% strain”) and generally maintain or improve the Notched Izod Impact Resistance value, tensile strength at yield and Vicat. Regarding ESCR, after seven days immersion, the tensile bars of Experiments 5 through 10 exhibit at least 20% retention of elongation at break, with some having at least 30%, while the Experiments 1 through 4 and 11 not representing the present invention retain 13% or less of their original elongation.

In a further set of experiments the physical properties of the compositions according to the present invention are shown. The Polybutadiene rubber is Diene 55 from Firestone. The blended PAO composition shown in Table 5 was the same 1:1 weight ratio blend of the two indicated components as shown in Table 2 prepared in advance by mixing. The process to make the resin is similar to example 1, except for variation in the total amount of nDM addition. In this example small variations were made to the nDM addition to obtain final products with similar slightly smaller rubber particle sizes and comparable melt flow rates. The final polymer compositions contained about 3.5 weight percent PAO, about 8.5 to 9.0 weight percent rubber, and the balance polystyrene, calculated based on the feed composition and conversion during polymerization.

The resulting products were tested according to the methods shown in Table 6 and the results shown in Table 7.

TABLE 5
Feed Compositions

| | | PAO |
|---|---|---|
| Feed Composition | Experiment 1 | Experiments |
| Polybutadiene rubber (wt %) | 7.6 | 7.6 |
| Ethylbenzene (wt %) | 4 | 4 |
| PAO - Spectrasyn 40/10 (wt %) | 0 | 2.9 |
| Styrene | Balance | Balance |
| Mineral Oil (wt %) | 2.9 | 0 |
| Irganox 1076 (wt %) | 0.1 | 0.1 |
| Trigonox 22 (ppm) | 120 | 120 |
| nDM feed (ppm) | 60 | 100 |
| nDM total (ppm) | 260 | 300 |

TABLE 6
Test methods

| | |
|---|---|
| Rubber Particle Size (RPS) | Coulter Multisizer 30 μm |
| Tensile Properties | ASTM D-638 |
| Notched Izod Impact Resistance | ASTM D-256 |
| Vicat Softening Temperature | ASTM D-1525 (120° C./h) |

TABLE 7
Test results

| | | Dyn Visc | RPS | n | Δ n | | Δ | Yield | Δ Yield |
|---|---|---|---|---|---|---|---|---|---|
| | | @40° C. | mean | Izod | Izod | Vicat | Vicat | Strength | Strength |
| Expt | ESCR Additive | cP | μm | J/m | % | ° C. | % | MPa | % |
| 12* | WMO | | 2.0 | 181 | | 99.4 | | 17.9 | |
| 13 | Spectrasyn 40/10 | 124** | 2.4 | 228 | 26 | 102.4 | 3 | 19.1 | 7 |

*Comparative Experiment -- not an example of the present invention
**Calculated using Refutas method

Although the invention has been described in considerable detail, this detail is for the purpose of illustration and is not to be construed as a limitation on the scope of the invention as described in the pending claims. All references identified above, and for purposes of U.S. patent practice, particularly all U.S. patents, allowed patent applications, and published patent applications identified above, are incorporated herein by reference.

1. A composition comprising (A) a rubber-modified monovinylidene aromatic polymer, and (B) an effective amount of a poly-alpha-olefin (PAO) having a dynamic viscosity of from about 40 to about 500 centipoise (cP) at 40° C.

2. The composition of claim 1 in which the PAO is present in an amount of from at least about 0.1 to about 10 weight percent based on the combined weight of the rubber-modified monovinylidene aromatic polymer and the PAO.

3. The composition of claim 2 in which the dynamic viscosity of the PAO is at least about 50 cP at 40° C.

4. The composition of claim 2 in which the dynamic viscosity of the PAO is less than or equal to about 400 cP at 40° C.

5. The composition of claim 1 in which the rubber-modified monovinylidene aromatic polymer is rubber-modified polystyrene (HIPS) or butadiene rubber-modified poly(styrene-acrylonitrile) (ABS).

6. The composition of claim 1 in which the PAO is an oligomer based on one or more of the alpha olefin monomers selected from group comprising hexene, octene, decene, dodecene, and tetradecene.

7. The composition of claim 1 in which the PAO is an oligomer based on a mixture of the alpha olefin monomers octene, decene, and dodecene.

8. The composition of claim 1 in which the PAO is an oligomer based on a mixture of alpha olefin monomers comprising decene.

9. The composition of claim 1 in which the PAO is an oligomer based on a mixture of alpha olefin monomers comprising dodecene.

10. The composition of claim 1 in which the PAO is present in an amount of from at least about 1 to about 7 weight percent based on the combined weight of the rubber-modified monovinylidene aromatic polymer and the PAO.

11. The composition of claim 1 wherein the notched Izod impact resistance when tested according to ISO 180/1A is improved by at least 10 percent as compared to a reference sample containing no PAO.

12. The composition of claim 11 wherein the notched Izod impact resistance is improved by at least 20 percent.

13. The composition of claim 12 wherein the notched Izod impact resistance is improved by at least 30 percent.

14. The composition of claim 1 in which a test specimen prepared from the composition when tested according to the procedure of ISO 527-2 retains more than 30% of its original elongation after seven days exposure to corn oil at 1% strain in accordance with the procedure of ISO-4599.

15. The composition of claim 14 in which the test specimen retains more than 40% of its original elongation.

16. The composition of claim 15 in which the test specimen retains more than 50% of its original elongation.

17. The composition of claim 1 in which a test specimen prepared from the composition when tested according to the procedure of ASTM D-1525 (120° C./h) exhibits a Vicat heat resistance temperature of greater than 102° C.

18. A process for preparing an improved rubber-modified monovinylidene aromatic polymer comprising the step of admixing with the rubber-modified monovinylidene aromatic polymer an effective amount of a PAO having a dynamic viscosity of from about 40 to about 500 centipoise (cP) at 40° C.

19. The process of claim 18 in which the PAO is admixed with the rubber-modified monovinylidene aromatic polymer by addition to the polymerization process prior to or at the time the polymer is prepared by polymerization of its constituent monomers.

20. An article comprising the composition of claim 1.
